(19) United States
(12) Patent Application Publication
(10) Pub. No.: US 2005/0061717 A1
(43) Pub. Date: Mar. 24, 2005

(54) Gravel Changer

(76) Inventor: Gary Lynn Smith, Belleville, IL (US)

Correspondence Address: Gary Lynn Smith, 1313 Orchard Street, Belleville, IL, 62221, US

(21) Appl. No.: 10/666,758

(22) Filed: Sep. 22, 2003

(51) Int. Cl. B07B 1/49

(52) U.S. Cl. 209/418

(57) ABSTRACT

The Gravel Changer which is new in the art of changing and or removing gravel out of fish tanks is an original product created for consumers who own fish tanks and are looking for a quick and easy way to redecorate their tanks with new gravel.

### BACKGROUND OF THE INVENTION

The Gravel Changer is an original product, the Gravel Changer is the only product invented to change gravel out of fish tanks, other products power filters: Invented to remove debris from fish tanks, are designed to change water and debris out of fish tanks, my invention the Gravel Changer is designed to remove old gravel out of fish tanks and to be replaced with new gravel, original product.

### BRIEF SUMMARY OF THE INVENTION

The Gravel Changer is a useful product for fish tanks, invented to change old gravel out of fish tanks. My invention will appeal to consumers, its lightweight, easy to use, simply scoop the rocks out of the fish tank and replace with new rocks, before the Gravel Changer consumers used whatever they could find to remove old rocks out of their fish tanks when they wanted new rocks and it was hard work, now the Gravel Changer will make changing gravel easy. The Gravel Changer will have flat shovel a round housing to hold the rocks, drain holes at the end and a hollow handle at the very top allowing consumers to scoop the rocks out of their tanks, the Gravel Changer will also be available in small, medium and large for different size tanks and will be available and manufactured in a variety of colors.

### BRIEF DESCRIPTION OF THE SEVERAL VIEWS OF THE DRAWING

FIG. 1 Fish tank: Drawing shows Gravel Changer inside tank scooping rocks.

FIG. 2 Flat Shovel: Used to scoop up the gravel.

FIG. 3 Gravel: Being scooped on the flat shovel into the Gravel Changer.

FIG. 4 Gravel Changer: Holds the gravel to be disposed of.

FIG. 5 Hollow Handle: Connected to the Gravel Changer.

FIG. 6 Water Drain: After gravel is scooped into the Gravel Changer the water will drain out through the drain holes, no mess gravel can now be disposed of.

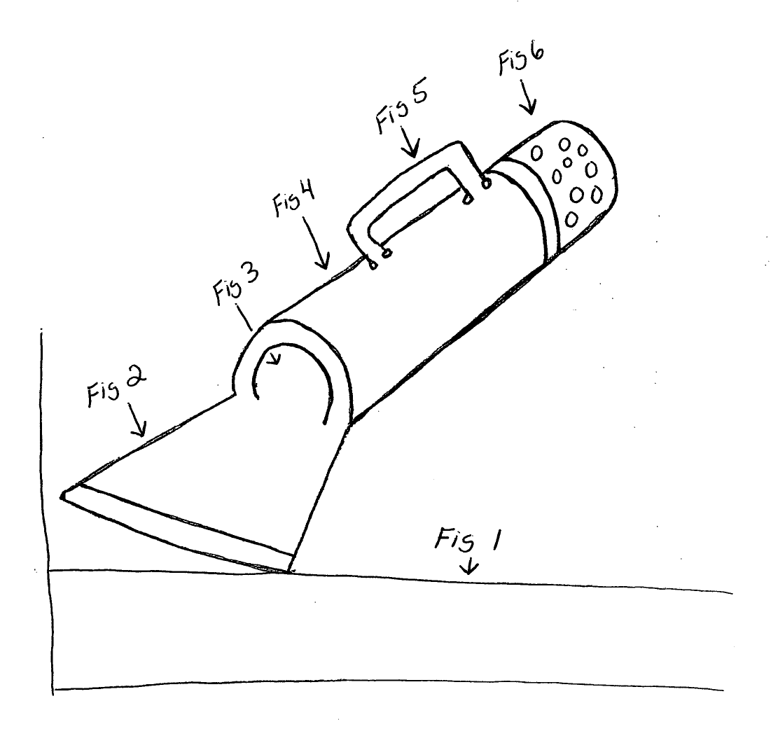

### DETAILED DESCRIPTION OF INVENTION

The Gravel Changer has a flat shovel connected to a round housing that holds rocks and drain holes at the end of the housing allowing water to drain out, The Gravel Changer, also has a hollow handle centered at the very top of the Gravel Changer making it possible to hold the light weight Gravel Changer allowing the consumer to scoop out the old gravel, no mess simply scoop out the old gravel into the Gravel Changer let the water drain inside the tank and dispose the old gravel until all gravel is removed. The Gravel Changer will also create sales, after old rocks are removed, new rock will be purchased also fish decorations and chemicals for fish tanks etc: My product will make redecorating tanks easy.

1. What I claim as my invention is gravel changer:
The gravel changer is a product created, invented to change old gravel out of fish tanks, the gravel changer will appeal to all consumers who want convenience and a quick and easy way to change gravel out of their fish tanks:
My Product is an original and will boost sales in gravel, fish, decorations etc. The Gravel Changer is a product fish tank owner's will love to have.
